(19) United States
(12) Patent Application Publication
(10) Pub. No.: US 2008/0003946 A1
(43) Pub. Date: Jan. 3, 2008

(54) Connection setting method between devices on wireless personal area networks

(75) Inventors: Sung Hwan Lee, Yongin-si (KR); Jin Young Yang, Yongin-si (KR); Ki Soo Chang, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/713,690

(22) Filed: Mar. 5, 2007

(30) Foreign Application Priority Data
Jun. 30, 2006 (KR) 10-2006-0060322

(51) Int. Cl. H04B 7/00

(52) U.S. Cl. 455/41.2

(57) ABSTRACT

A connection establishment apparatus and method between devices located on a WPAN are provided. The apparatus includes a control module that wakes up a ZigBee channel; a Zigbee module that scans at least one device located on the WPAN using the ZigBee channel and acquires Bluetooth connection information from the scanned device using the ZigBee channel; and a Bluetooth module that performs Bluetooth paging with the other devices by using the Bluetooth connection information, and establishes a Bluetooth piconet.

### CROSS-REFERENCE TO RELATED APPLICATION

This application claims priority from Korean Patent Application No. 10-2006-0060322, filed on Jun. 30, 2006, in the Korean Intellectual Property Office, the disclosure of which is incorporated herein by reference.

### BACKGROUND OF THE INVENTION

1. Field of the Invention

The present invention relates to a device discovery method performed in Bluetooth communication and a connection establishment method between devices located on a wireless personal area network (WPAN). More particularly, the present invention relates to a device discovery method performed in Bluetooth communication and a connection establishment method located on the WPAN, which can establish a Bluetooth piconet by acquiring Bluetooth connection information, including Bluetooth address information and clock offset information, from at least one device located on the WPAN using a ZigBee channel, and performing Bluetooth paging with the other devices by using the Bluetooth connection information.

2. Description of Related Art

Recently, as a people's interest to a home networking becomes increased, a WPAN technique that is a personal networking solution utilized in a local area, i.e. in a range of approximately 10 meters, has become the focus of attention. The WPAN indicates data transmission in a local area, i.e. in a range from approximately several tens of centimeters to several tens of meters, and a personalized wireless network for smooth communication with devices in a neighborhood. The WPAN is known as a brilliant solution since it does not require a communication infrastructure due to its characteristics, is easily applicable to various types of devices, and has low cost and power efficiency.

The WPAN under the Institute of Electrical and Electronics Engineers (IEEE) 802.15 standard has various working groups (WG) including four task groups (TG) discussing the IEEE 802.15 standard, and carrying out various activities for the standard. There is Bluetooth defined by IEEE 802.15.1, ZigBee defined by IEEE 802.15.4, UWB defined by IEEE 802.15.3a, and the like, as ancillary concepts of the WPAN under the IEEE 802.15.

Bluetooth of the IEEE 802.15.1 standard, which is the most widely utilized WPAN, indicates a short range wireless connectivity technique, using a frequency in a band of 2.4 GHz, and is vigorously applied to and utilized for various digital home appliances, e.g. a computer, a printer, a mobile phone, and the like, in addition to other communication devices. Specifically, Bluetooth is widely utilized in a configuration of a mobile device, e.g. a mobile communication terminal. When the wireless connectivity technique is applied to the mobile device with an ad hoc network configuration for data transmission between devices in a personal area network, depending upon the network connection, power consumption may become an important issue. Also, it may become an important issue how quickly the wireless connectivity technique can connect with peripheral devices to provide users with convenient connectivity.

Generally, since a network connection between devices using Bluetooth takes a significant amount of time and power, the network connection between devices using Bluetooth is not effective in view of cost and power efficiency.

Accordingly, a WPAN connection technique which can effectively provide WPAN connection between devices by quickly performing connection between devices and minimizing power consumption is earnestly desired.

### SUMMARY OF THE INVENTION

Accordingly, it is an aspect of the present invention to provide a device discovery method performed for Bluetooth communication and a connection establishment method between devices located on a WPAN, which can minimize the time for discovery of a Bluetooth connection by a device by scanning other devices located on an identical network using a ZigBee channel, and acquire Bluetooth connection information using the ZigBee channel from the scanned device.

Another aspect of the present invention provides a device discovery method performed for Bluetooth communication and a connection establishment method between devices located on a WPAN, which can minimize discovery time, and power consumption for the device required during the discovery time by scanning other devices located on an identical network using a ZigBee channel.

Another aspect of the present invention provides a device discovery method performed for Bluetooth communication and a connection establishment method between devices located on a WPAN, which can repeatedly establish a Bluetooth connection in a shorter period of time with less power consumption since other devices Bluetooth connection information acquired using a ZigBee channel is stored and maintained in a memory unit, and a Bluetooth connection with the other devices is repeatedly performed by using the Bluetooth connection information recorded in the memory unit, when Bluetooth connection is not reliable or is unintentionally released.

Another aspect of the present invention also provides a device discovery method performed for Bluetooth communication capable of readily and quickly forming an ad hoc network and a connection establishment method between devices located on a WPAN since Bluetooth connection information may be simultaneously exchanged with other devices during scanning operation by the scanning of other devices using a ZigBee channel.

According to an aspect of the present invention, there is provided a device discovery method performed for Bluetooth communication including: waking up a ZigBee channel; scanning at least one device located on an identical network using the ZigBee channel; and acquiring Bluetooth connection information from the scanned device using the ZigBee channel.

According to an aspect of the present invention, there is provided a connection establishment method between devices located on a WPAN including: waking up a ZigBee channel; scanning at least one device located on the WPAN using the ZigBee channel; acquiring Bluetooth connection information from the scanned device using the ZigBee channel; shutting down the ZigBee channel; and performing Bluetooth paging with the other device by using the Bluetooth connection information, and establishing a Bluetooth piconet.

According to another aspect of the present invention, there is provided a device establishing a WPAN connection including: a Zigbee module scanning at least one other device located on a WPAN using a Zigbee channel, and acquiring a Bluetooth connection information using the ZigBee channel from the scanned device; a Bluetooth module performing Bluetooth paging with the other devices by using the Bluetooth connection information, and establishing a Bluetooth piconet; and a control module controlling a shutdown of the ZigBee channel when the Bluetooth connection information is acquired.

### BRIEF DESCRIPTION OF THE DRAWINGS

The above and/or other aspects of the present invention will become apparent and more readily appreciated from the following detailed description, taken in conjunction with the accompanying drawings of which:

FIG. 1 is a diagram illustrating a time required for network connection between devices using a Bluetooth;

FIG. 2 is a block diagram illustrating a device configuration performing a device discovery method performed for Bluetooth communication according to an exemplary embodiment of the present invention;

FIG. 3 is a flowchart illustrating a device discovery method performed for Bluetooth communication according to an exemplary embodiment of the present invention;

FIG. 4 is a flowchart illustrating a connection establishment method between devices located on a WPAN according to an exemplary embodiment of the present invention; and

FIG. 5 is a flowchart illustrating a connection resetting method between the devices located on the WPAN according to an exemplary embodiment of the present invention.

### DETAILED DESCRIPTION OF THE EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to illustrate the various aspects of the present invention by referring to the figures.

Devices mentioned throughout the present specification indicate a wireless terminal which can connect to at least one device using Bluetooth and ZigBee. The devices may be embodied as devices having a Bluetooth and a ZigBee modules, e.g. a personal digital assistant (PDA), a cellular phone, a personal communication service (PCS) phone, a hand-held personal computer (PC), code division multiple access-2000 (CDMA-2000) 1X and 3X phones, a wideband CDMA (WCDMA) phone, a dual band/dual mode phone, a global system for mobile communications (GMS) phone, a mobile broadband system (MBS) phone, a satellite/terrestrial digital multimedia broadcasting (DMB) phone, and the like.

Also, the devices may be embodied as a wireless earset and a wireless headset capable of connecting to the above mentioned phones, and a portable game device, a Motion Picture Experts Group Audio Layer-3 (MP3) player, a portable multiple player (PMP). The devices may be embodied as home appliances, e.g. a refrigerator, a TV, a laundry machine, an audio system, or the like, which are connected by a home-network using Bluetooth and ZigBee modules. Further, the devices may be embodied by including all electronic devices capable of having the Bluetooth and ZigBee modules.

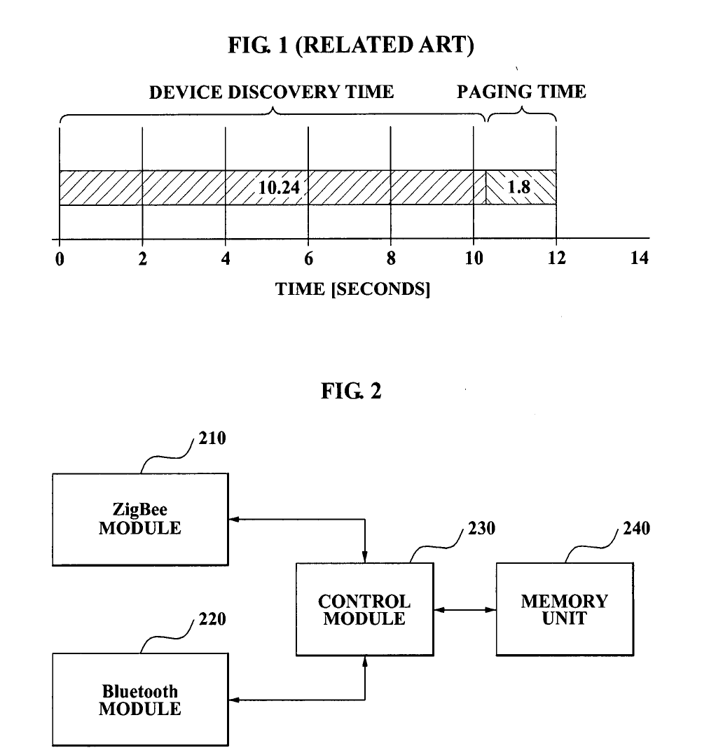

FIG. 1 is a diagram illustrating a time required for network connection between devices using Bluetooth. Basically, frequency hopping is utilized for the network connection between devices using Bluetooth. Namely, data communication between a master device and a slave device may be performed by establishing a Bluetooth piconet, after performing Bluetooth paging, and synchronizing a frequency hopping pattern between the master device and the slave device.

For the synchronizing of the frequency hopping pattern, address information of each device is required so that each device scans other devices located on an identical network during a device discovery duration, and exchanges address information of the scanned device. Subsequently, the Bluetooth piconet maybe established by the performing of the frequency hopping synchronization for a paging duration.

However, when using the Bluetooth method according to the related art, there is a problem in that it takes approximately 10.24 seconds for a discovery time to scan other devices, and approximately 115.5 mW of power is consumed for the discovery time, therefore performing discovery is not efficient for a mobile device.

FIG. 2 is a block diagram illustrating a device configuration performing a device discovery method performed for Bluetooth communication according to an exemplary embodiment of the present invention;

The device according to the exemplary embodiment of the present invention may include a master device or a slave device, in a Bluetooth connection with other devices located on an identical network. A device configuration and device operation are identical for both cases, i.e. the device is embodied as the master device or the device is embodied as the slave device, therefore, for convenience of description, the case the device is embodied as the master device will be taken as an example in FIG. 1.

The device according to the exemplary embodiment of the present invention includes a ZigBee module 210, a Bluetooth module 220, a control module 230 and a memory unit 240.

The ZigBee module 210 scans at least one other device module located on the WPAN using a ZigBee channel, and acquires Bluetooth connection information from the scanned device using the ZigBee channel. Specifically, when the device attempts to create a Bluetooth connection with the at least one other device located on an identical network, the device activates the ZigBee module 210 to wake-up a ZigBee channel.

When the ZigBee channel is woken up, the ZigBee module 210 scans at least one other device located on an identical network using the ZigBee channel. When the at least one other device located on the identical network is scanned, the ZigBee module 210 acquires the Bluetooth connection information from the scanned device using the ZigBee channel. Namely, each device's connection information for establishing a Bluetooth piconet may be acquiring by exchanging Bluetooth connection information with the scanned device.

The Bluetooth connection information includes device address information, clock offset information, and all information required for the Bluetooth connection between devices.

The described acquiring of the Bluetooth connection information acquires the Bluetooth connection information by being included in superframes being transmitted and received with the scanned device using the ZigBee channel. The superframes include beacon frames and data frames in a ZigBee communication method using slotted carrier sense multiple access/collision avoidance (CSMA/CA).

When the Bluetooth connection information of the scanned device is acquired using the ZigBee module 210, the control module 230 shuts down the ZigBee channel and activates the Bluetooth module 220.

The Bluetooth module 220 performs Bluetooth paging with the other devices by using the acquired Bluetooth connection information. Specifically, the Bluetooth module 220 performs synchronization for frequency hopping with the scanned device by using the Bluetooth address information and clock offset information of the scanned device included in the Bluetooth connection information.

The Bluetooth module 220 may establish the Bluetooth piconet with the scanned device by performing the Bluetooth paging. During the Bluetooth paging of the Bluetooth module 220, the control module 230 may suspend the ZigBee module 210 by shutting down the ZigBee channel. Also, the Bluetooth module 220 maintains a shutdown state according to a control of the control mode 230 during the scanning of the at least one other device and the acquiring of the Bluetooth connection information, and wakes up when the Bluetooth connection information is acquired.

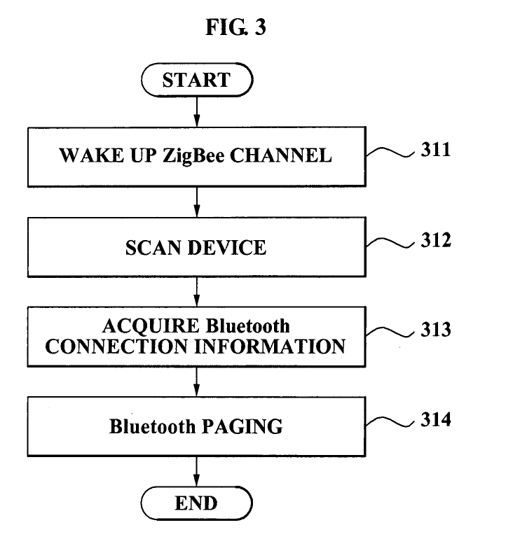

FIG. 3 is a flowchart illustrating a device discovery method performed in Bluetooth communication according to an exemplary embodiment of the present invention.

As with the device configuration and the device discovery method described in FIG. 2, when the device according to the present an exemplary embodiment of the present invention creates a Bluetooth connection with other devices located on an identical network, the device wakes-up a ZigBee channel in operation 311. In operation 312, the device scans at least one other device capable of ZigBee connection by using the wake-up ZigBee channel to acquire Bluetooth connection information in operation 313.

In operation 313, when the at least one other device is scanned, the device acquires Bluetooth connection information of the scanned device included in a superframe being transmitted and received with the other device using the ZigBee channel in operation 313. The Bluetooth connection information includes Bluetooth address information and clock offset information of the scanned device.

When the Bluetooth connection information is acquired, the device shuts down the ZigBee channel and performs Bluetooth paging with the scanned device by using the Bluetooth connection information in operation 314. The device may establish a Bluetooth piconet with the scanned device using the Bluetooth paging.

Referring back to FIG. 2, the control module 230 records and stores the acquired Bluetooth connection information in the memory unit 240. For storing the Bluetooth connection information, the memory unit 240 may include a Universal Serial Bus (USB), memories of various capacities, a Compact Flash (CF) memory, a Secure Digital (SD) memory, a mini SD memory, an Extreme Digital (XD) memory, a memory stick, a Memory Stick Duo, a spare memory cell (SMC) memory, a multi media card (MMC) memory, a memory including a Reduced Size Multimedia Card (RS-MMC), and a hard disc utilized in a personal computer and a notebook computer. Also, the memory unit 240 may be a built-in type installed as an inner configuration of the device or an external type installed to an outside of the device. In addition to this, the memory unit 240 may include any types of memory types which may be potentially developed, e.g. a Phase-change RAM (PRAM), a ferroelectric random access memory (FRAM), a magnetic random access memory (MRAM).

As described above, when the Bluetooth connection information of the scanned device is stored and maintained in the memory unit 240, when the established Bluetooth piconet with the scanned device is not reliably connected or is unintentionally released, the Bluetooth piconet connection may be readily reestablished by using the stored Bluetooth connection information.

Namely, when the established Bluetooth piconet connection with the scanned device is not reliable or is unintentionally released, the control module 230 wakes up the Zigbee channel in the shutdown state by controlling the ZigBee module 210. Also, the control module 230 reads from memory unit 240, Bluetooth connection information of a device whose established Bluetooth piconet is unintentionally released.

The ZigBee module 210 scans the device whose established Bluetooth piconet is unintentionally released by using the read Bluetooth connection information. When the device is scanned, the control module 230 shuts down, controls the Bluetooth module 220, performs Bluetooth paging with the scanned device, and subsequently reestablishes the Bluetooth piconet with the scanned device.

As described above, in the Bluetooth communication between devices according to the present invention, the device discovery operation, i.e. when a master device scans a slave device and exchanges address information and clock offset information, is performed using the ZigBee. It takes only approximately 0.03 seconds to perform the device discovery operation using the ZigBee, which is a dramatically shorter device discovery time than 10.24 seconds required in a conventional Bluetooth.

Also, when the device discovery operation is performed using ZigBee, since power consumption required for the discovery duration is only 36 mW, the power consumption is significantly reduced from 115.5 mW power consumption of a conventional Bluetooth device discovery operation.

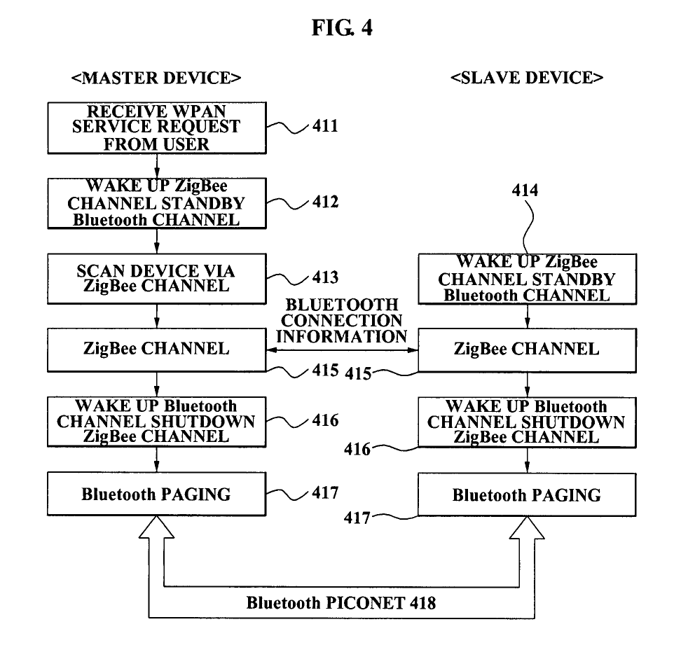

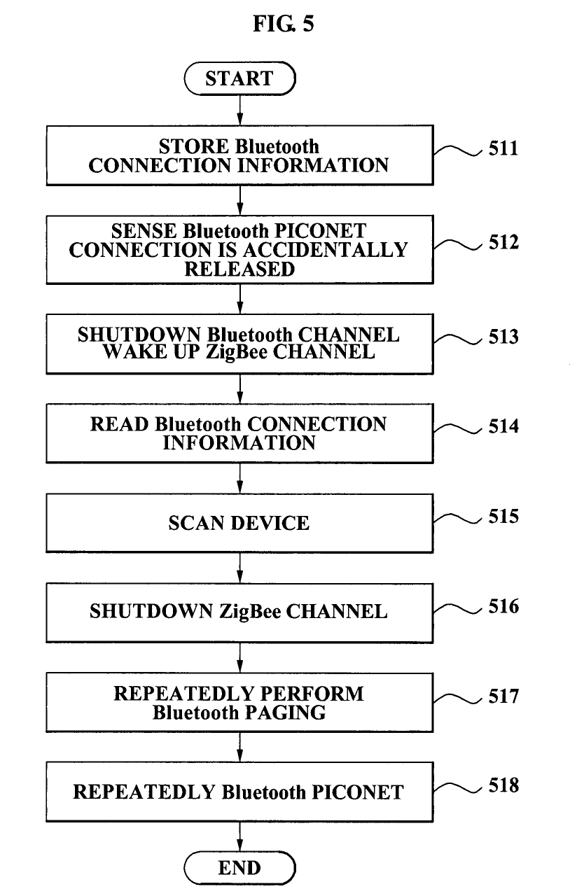

The device discovery operation performed in Bluetooth communication according to the present invention may be applied to a connection establishment method between devices located on a WPAN to be embodied. The connection establishment method will be described by referring to FIGS. 4 and 5.

FIG. 4 is a flowchart illustrating a connection establishing method between devices located on a WPAN according to an exemplary embodiment of the present invention.

The connection establishment method between devices located on the WPAN may be embodied via a master device and a slave device. The master device and the slave device may include a ZigBee module for ZigBee communication and a Bluetooth module for Bluetooth communication.

In operation 411, the master device receives a WPAN service request, and in operation 412 the master device wakes up a ZigBee channel. In operation 412, the Bluetooth channel may be maintained in a standby state or a shutdown state.

In operation 413, after the ZigBee channel wakes up, the master device scans at least one other device located on the WPAN using the ZigBee channel.

When the slave device is scanned after operation 413, the master device exchanges and acquires Bluetooth connection information from the scanned slave device using the ZigBee channel in operation 415. The Bluetooth connection information includes address information and clock offset information of the slave device. The slave device wakes up the ZigBee channel in operation 414, maintains the Bluetooth channel in a standby state or a shutdown state, and having established a ZigBee channel connection with the master device in operation 415, the Bluetooth connection information may be exchanged with the master device in operation 415.

The master and the slave devices acquire each other's Bluetooth connection information in operation 415, and, then, respectively wakes up the Bluetooth channel, and shuts down the ZigBee channel in operation 416. In operation 417, the master device and the slave device perform Bluetooth paging according to frequency hopping synchronization operation by using the acquired Bluetooth connection information of a corresponding device. According to the Bluetooth paging operation, a Bluetooth piconet is established between the master and slave devices, so that Bluetooth communication may be performed with each other in operation 418.

FIG. 5 is a flowchart illustrating repeatedly performing of a connection establishment method between the devices located on the WPAN when a connection between the devices is not reliable, according to an exemplary embodiment of the present invention.

As illustrated in FIG. 5, in operation 511, when the Bluetooth piconet is established between the devices, the devices respectively record and store the acquired Bluetooth connection information of the corresponding devices in a memory unit.

Subsequently, when the connection between the devices using the established Bluetooth piconet is not reliable or is unintentionally released, each of the devices standby or shutdown the Bluetooth channel in operation 512, and wake up a ZigBee channel in operation 513.

In operation 514, the each of the devices reads the stored Bluetooth connection information of the corresponding device, and the each of the devices scans the corresponding device by using the read Bluetooth connection information in operation 515. After the corresponding device is scanned in operation 515, each of the devices shuts down the ZigBee channel in operation 516, and repeatedly performs Bluetooth paging with the corresponding device by using the Bluetooth connection information in 517. In operation 518, a Bluetooth piconet between the devices may be repeatedly established.

The connection establishment method between the devices located on the WPAN according the present exemplary embodiment of the present invention by referring to FIGS. 4 and 5 may include the device discovery method according to the exemplary embodiment of the present invention described with reference to FIGS. 2 and 3.

Also, the device discovery method performed in the Bluetooth communication according to the above-described exemplary embodiments of the present invention and the connection establishment method between the devices located on the WPAN according to the above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

According to the device discovery method performed for Bluetooth communication and a connection establishment method between the devices located on the WPAN according to the above-described exemplary embodiments of the present invention, a device discovery time for establishing a Bluetooth connection may be minimized by scanning other devices located on an identical network using a ZigBee channel and acquiring Bluetooth connection information using the ZigBee channel from the scanned device.

Also, according to the device discovery method performed for Bluetooth communication and the connection establishment method between the devices located on the WPAN according to the above-described exemplary embodiments of the present invention, the discovery time, and also the power consumption for the device required during the discovery time may be minimized by scanning other devices located on an identical network using a ZigBee channel.

Also, according to the device discovery method performed for Bluetooth communication and the connection establishment method between the devices located on the WPAN according to the above-described exemplary embodiments of the present invention, a Bluetooth reconnection may be performed more quickly with less power consumption since the other devices' Bluetooth connection information is acquired using the ZigBee channel and stored and maintained in the memory unit, and the Bluetooth connection with the other devices may be repeatedly performed by using the Bluetooth connection information recorded in the memory unit, when a Bluetooth connection is not reliable or is unintentionally released.

Also, according to the device discovery method performed for Bluetooth communication and the connection establishment method between the devices located on the WPAN according to the above-described exemplary embodiments of the present invention, an ad hoc network between devices may be more readily and quickly formed since Bluetooth connection information may be simultaneously exchanged with other devices during a scanning operation by the scanning of other devices using ZigBee.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed:

1. A device discovery method performed for Bluetooth communication, the method comprising:
waking up a ZigBee channel;
scanning at least one device located on a network using the ZigBee channel; and
acquiring Bluetooth connection information from the scanned at least one device using the ZigBee channel.

2. The method of claim 1, wherein the Bluetooth connection information comprises at least one of address information and clock offset information of the at least one device.

3. The method of claim 1, wherein the acquiring the Bluetooth connection information comprises acquiring the Bluetooth connection information included in superframes being transmitted and received with the at least one device using the ZigBee channel.

4. A connection establishment method between devices located on a wireless personal area network (WPAN), the method comprising:
waking up a ZigBee channel;
scanning at least one device located on the WPAN using the ZigBee channel;
acquiring Bluetooth connection information from the scanned at least one device using the ZigBee channel;
shutting down the ZigBee channel; and
performing Bluetooth paging with the at lease one device by using the Bluetooth connection information, and establishing a Bluetooth connection.

5. The method of claim 4, further comprising:
storing the Bluetooth connection information in a memory unit;
shutting down the Bluetooth channel and waking up the ZigBee channel when the Bluetooth piconet connection with the at least one device is unintentionally released;
reading the Bluetooth connection information of the at least one device from the memory unit, and scanning the at least one device using the Bluetooth connection information;
shutting down the ZigBee channel when the at least one device is scanned, and
repeatedly performing the Bluetooth paging with the other devices by using the Bluetooth connection information, and establishing a Bluetooth connection.

6. The method of claim 4, wherein the Bluetooth connection information comprises at least one of address information and clock offset information of the at least one device.

7. The method of claim 4, wherein the acquiring the Bluetooth connection information comprises acquiring the Bluetooth connection information included in a superframe being transmitted and received with the at least one device using the ZigBee channel.

8. A computer-readable storage medium storing a program for implementing the method according to claim 1.

9. A wireless personal area network (WPAN) device comprising:
a Zigbee module that scans at least one device located on a WPAN using a Zigbee channel, and acquires Bluetooth connection information using the ZigBee channel from the scanned at least one device; and
a Bluetooth module that performs Bluetooth paging with the at least one device using the Bluetooth connection information and establishes a Bluetooth connection

10. The device according to claim 9, further comprising a control module that controls a shutdown of the ZigBee channel when the Bluetooth connection information is acquired.

11. The device of claim 9, further comprising:
a memory unit that stores the Bluetooth connection information; and
a control module that stores the Bluetooth connection information in the memory unit.

12. The device of claim 10, further comprising:
a memory unit that stores the Bluetooth connection information,
wherein the control module stores the Bluetooth connection information in the memory unit.

13. The device according to claim 11, wherein when the established Bluetooth connection becomes unreliable or unintentionally released, the control module reads the Bluetooth connection information from the memory unit and controls the Zigbee module to scan the at least one device using the read Bluetooth connection information.

14. The device according to claim 12, wherein when the established Bluetooth connection becomes unreliable or unintentionally released, the control module wakes up the Zigbee channel, reads the Bluetooth connection information from the memory unit and controls the Zigbee module to scan the at least one device using the read Bluetooth connection information.
